(19) United States
(12) Patent Application Publication
(10) Pub. No.: US 2026/0181391 A1
(43) Pub. Date: Jun. 25, 2026

(54) TRANSFERRING PASSKEYS BETWEEN MOBILE DEVICES

(71) Applicant: American Express Travel Related Services Company, Inc., New York, NY (US)

(72) Inventors: Ajay Babu Maddukuri, Phoenix, AZ (US); Mukund Shankar SimhaRaghu, Glendale, AZ (US)

(21) Appl. No.: 18/987,815

(22) Filed: Dec. 19, 2024

(51) Int. Cl. H04W 12/06; H04W 12/041

(52) U.S. Cl. CPC H04W 12/068; H04W 12/041

(57) ABSTRACT

The various embodiments describe approaches to transfer passkey credentials between client devices. In one example, a first client device is configured to identify a passkey request for logging into a domain device and generate a payload for a second client device to sign. A near field communication (NFC) session with the second client device is initiated. The payload is transmitted, via the NFC session, to the second client device. A signed payload is received from the second client device and transmitted to the domain device for granting the first client device access.

### BACKGROUND

Password credentials have been a traditional mechanism for users to access a domain site (e.g., a website, a mobile application, etc.). However, traditional passwords have many problems. Some common problems can include users reusing passwords at multiple domain sites, user frustration for changing passwords on a periodic basis, user frustration with having to remember complicated passwords, and other problems. As such, passkeys were created as a more convenient and secure alternative to traditional passwords. However, users are restricted in their use of passkeys.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing depicting scenario of users performing a passkey transfer according to various embodiments of the present disclosure.

FIG. 2 is a drawing of a network environment according to various embodiments of the present disclosure.

FIG. 3 is a flowchart illustrating one example of functionality implemented as portions of a client application executed in a client device in the network environment of FIG. 2 according to various embodiments of the present disclosure.

FIGS. 4A and 4B are flowcharts illustrating examples of functionality implemented as portions of a client application executed in a client device in the network environment of FIG. 2 according to various embodiments of the present disclosure.

FIG. 5 is a flowchart illustrating one example of functionality implemented as portions of an authentication service executed in a computing environment in the network environment of FIG. 2 according to various embodiments of the present disclosure.

### DETAILED DESCRIPTION

The various embodiments of the present disclosure are directed to various approaches for transferring passkeys between mobile devices using a near field communication (NFC) wireless protocol. As previously stated, passkeys are emerging as a replacement for traditional passwords because of various convenience and security reasons. A passkey can be defined a cryptographic credential that is associated with a user's account on a particular domain site (e.g., a website or an application). As part of the passkey verification process, a user's client device can verify the user (e.g., by performing a biometric scan such as facial recognition, fingerprint scanning, voice fingerprinting, etc.) to verify the user and digitally signs an authentication challenge (e.g., a payload) from the domain site. The signed authentication challenge is sent to the domain site to verify the identity of the user, in which subsequently the user is granted access upon a successful verification. However, existing implementations of passkeys have significant restrictions on the use of the passkeys.

Accordingly, the embodiments of the present disclosure provide several advantages relating to transferring passkeys between mobile devices and/or between user profiles. For example, each mobile device can be associated with a separate user account at a particular domain site. Alternatively, the receiving mobile device may not have a user account at the particular domain site.

Often, existing passkey implementations have significant restrictions on passkey use because of security concerns. For example, existing implementations of passkeys do not permit the transfer of passkeys between two separate user accounts, in which each user account is associated with a separate mobile device. As such, the embodiments provide functionality for permitting transfers of passkeys to different client device or authorization of the different client device to use the passkey. Additionally, the embodiments of the present disclosure describe multiple, secure implementations for transferring passkeys using an NFC protocol. The embodiments use an NFC protocol because the short data session in terms of time and the short transmission range severely limit the session exposure to malicious users. In addition, the embodiments provide enhanced functionality for the users to select the types of passkey transfers, to select which devices for transferring a passkey, and other improvements. As such, the embodiments of the present disclosure enable this additional functionality while also having security controls of the passkeys. In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

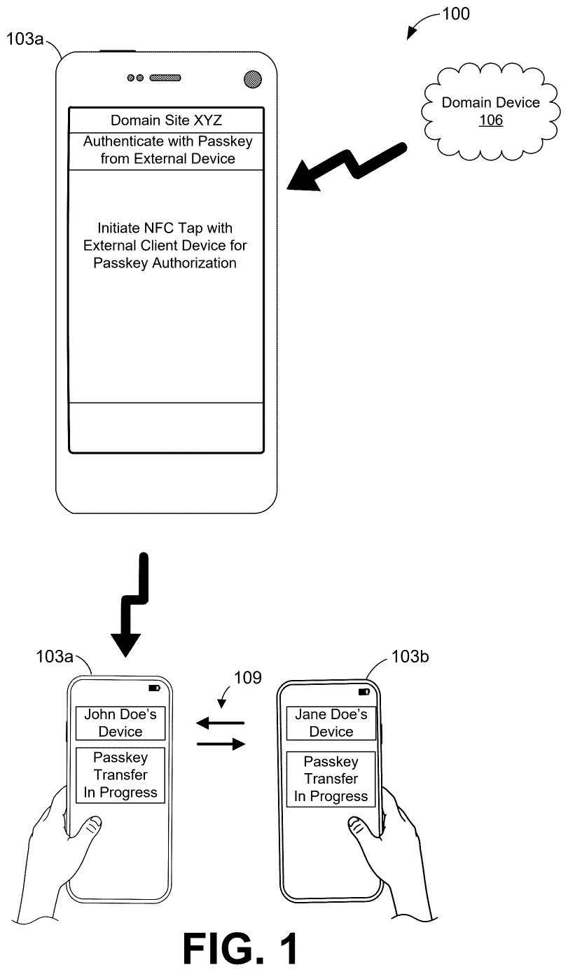

As illustrated in FIG. 1, shown is a networked environment 100 of client devices 103 transferring a passkey between each other. The networked environment 100 includes a first client device 103a, a second client device 103b (collectively “the client devices 103”), a domain device 106, and other suitable components, which are in data communication with each other via a wide area network. The domain device 106 can represent a networked computing device that hosts a website, an application, or other networked resources.

In the illustrated example, the first client device 103a is attempting to login into a domain site hosted by the domain device 106. Some non-limiting examples of the domain site can include a merchant check out page for purchasing an item, a bank site for accessing a payment credential, a multimedia site for accessing a media item, a mobile application for accessing a user account, and other suitable network resource scenarios.

Upon accessing the domain site, the first client device 103a receives a passkey request for logging in. In some examples, the first client device 103a can provide a first option for retrieving a passkey stored on the first client device 103a or a second option for retrieving a passkey from an external device. Upon selecting the second option, the first user can use the first client device 103a to select a second user identifier for a second user from a contact list. Upon a selection of the second user identifier, the first client device 103a transmits a push notification to the second client device 103b associated with the second user identifier. The second client device 103b can display the push notification and the push notification can request permission for the first user to authorize the use of the passkey associated with the second user identifier.

Upon agreeing to the authorization, the first client device 103a and the second client device 103b can initiate a data session via a local area network 109 for providing authorization for the first user to use the passkey of the second user. In some examples, the local area network is a near field communication (NFC) wireless protocol and the data session is an NFC session. For an NFC session, the client devices 103 can be placed in close proximity (e.g., adjacent or near adjacent to each other) for maintaining data communication during the NFC session. Through the NFC session, the second client device 103b can transmit authorization to the first client device 103a. However, other implementations could use other short-range wireless communication protocols, such as BLUETOOTH, ultra-wideband (UWB), or similar technologies.

In some examples, the second user can provide authorization by performing a biometric scan (e.g., facial recognition, fingerprint scanning, voice fingerprinting, etc.). Upon completing the biometric scan, the second client device 103b can digitally sign a payload that authorizes the use of the passkey of the second user. After the payload has been signed, the second client device 103b can transmit the signed payload to the first client device 103a via the NFC session. The first client device 103a can transmit the signed payload to the domain device 106 for verification. The signed payload can include a digital signature generated by the second client device 103b and a second user identifier associated with the passkey at the domain device 106. Upon verifying the digital signature for the second user identifier, the domain device 106 can authorize the first client device 103a to have access to the domain site or to execute the requested task (e.g., make a payment with a payment credential).

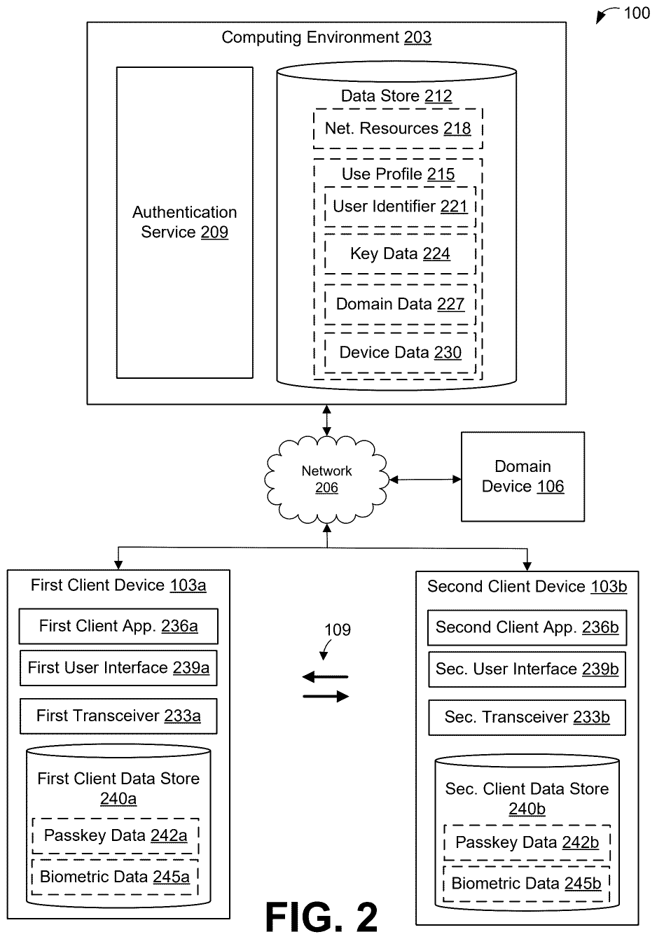

With reference to FIG. 2, shown is a block diagram of the network environment 100 according to various embodiments. The network environment 100 can include a computing environment 203, a first client device 103a, a second client device 103b, and a domain device 106, which can be in data communication with each other via a network 206.

The network 206 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 206 can also include a combination of two or more networks 206. Examples of networks 206 can include the Internet, intranets, extranets, virtual private networks (VPNs), and similar networks.

The computing environment 203 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 203 can employ a plurality of computing devices that can be arranged in one or more server banks or computer banks or other arrangements. Such computing devices can be located in a single installation or can be distributed among many different geographical locations. For example, the computing environment 203 can include a plurality of computing devices that together can include a hosted computing resource, a grid computing resource or any other distributed computing arrangement. In some cases, the computing environment 203 can correspond to an elastic computing resource where the allotted capacity of processing, network, storage, or other computing-related resources can vary over time.

Various applications or other functionality can be executed in the computing environment 203. The components executed on the computing environment 203 include an authentication service 209, and other applications, services, processes, systems, engines, or functionality not discussed in detail herein.

The authentication service 209 can be executed to verify user identities of the users attempting to access network resources by way of a passkey credential. The authentication service 209 can also be executed to facilitate the management of passkey data for user profiles/accounts.

Also, various data is stored in a data store 212 that is accessible to the computing environment 203. The data store 212 can be representative of a plurality of data stores 212, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 212 is associated with the operation of the various applications or functional entities described below. This data can include user profiles 215, network resources 218, and potentially other data.

The user profile 215 can represent a user account or a profile for individual users associated with computing environment 203. The user profile 215 can store data associated with passkeys for the computing environment 203, data associated with the domain device 106, or other suitable entities. The user profile 215 can include a user identifier 221, key data 224, domain data 227, device data 230, and other suitable data.

The user identifier 221 can represent unique identifiers associated with a particular user. The user identifier 221 can represent a unique identifier for the user at the computing environment 203, at a particular domain device 106, and/or other suitable environments. For example, the first client device 103a may have a first user identifier 221 for a first domain site and a second user identifier 221 for a second domain site. Each of these user identifiers 221 can each be associated with a separate passkey for verifying an identity of the user at the particular domain site.

The key data 224 can represent data associated one or more passkeys of a user. The key data 224 can include data associated with asymmetric key pairs (e.g., public-private key pairs), symmetric key data, domain identifiers, and other suitable data. The key data 224 can also include a history of user authorizations of the passkeys by other users. For example, the historical data can include a log or a list of a user (e.g., a first user identifier 221) authorizing other user identifiers 221 to use a passkey associated with the user. The historical data can include a log of a timestamp (e.g., day, time), a domain identifier, authorization transfer type (e.g., one time use, permanent transfer, etc.), domain type (e.g., media domain, merchant domain), authorization type (e.g., purchase, access a media item, productivity service) and other suitable historical data.

The domain data 227 can represent data associated with one or more domain devices 106. For example, the domain data 227 can include a domain identifier, an electronic address (e.g., an Internet Protocol address) for the domain device 106, and other suitable data.

The device data 230 can include data associated with a client device 103 for the user profile 215. The device data 230 can include a phone number, a mobile device identifier, a device advertiser identifier, an operating system identifier, device type, and other suitable data. The device data 230 can include data associated with one or more passkeys. The device data 230 can include information on which passkeys are associated with a specific client device 103.

The network resource 218 can represent network data or network service that is accessible to a client device 103 after verifying a valid passkey. Some examples of network resources 218 can include media items, a payment service, productivity data, and other suitable network resource.

The client device 103 is representative of a plurality of client devices (e.g., the first client device 103a, the second client device 103b) that can be coupled to the network 206. The client device 103 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 103 can include one or more displays, such as liquid crystal displays (LCDs), gas plasma-based flat panel displays, organic light emitting diode (OLED) displays, electrophoretic ink (“E-ink”) displays, projectors, or other types of display devices. In some instances, the display can be a component of the client device 103 or can be connected to the client device 103 through a wired or wireless connection.

The client device 103 can include one or more transceivers 233 (e.g., a first transceiver 233a and a second transceiver 233b can be collectively referred to as “the transceivers 233”) for data communication in the network environment 100. For example, the transceiver 233 can be a near field communication (NFC) transceiver for communicating according to an NFC wireless protocol with other client devices 103. In some examples, the NFC transceiver can have an operating distance for data communication of less than four inches between devices. The client device 103 can include other transceivers for data communication using a cellular network, a Wi-Fi network, BLUETOOTH®, ZIGBEE® network, Radio Frequency Identification (RFID), ultra-wideband (UWB), or any other suitable wireless communication medium or protocol. Additionally, the client device 103 can include a biometric sensor for capturing a biometric scan of the user for verifying a user identity during a passkey authorization process. The biometric sensor can include a camera, a fingerprint scanner, a microphone, and other suitable biometric sensors.

The client device 103 can be configured to execute various applications such as a client application 236 (representative of a first client application 236a and a second client application 236b) or other applications. The client application 236 can be executed to facilitate the management and use of passkeys. The client application 236 can facilitate the generation of a passkey, a transfer of a passkey, a verification of a passkey, and other suitable functionality associated with passkey. The client application 236 can also be executed to perform a biometric scan for verifying a user identity, in which the user intends to use a passkey.

The client devices 103 can initiate a data session via a local area network 109. In some examples, the local area network is an NFC wireless protocol and the data sessions are NFC sessions. In these examples, the client devices 103 are placed in close proximity for enabling NFC sessions. In some instances, the distances between the client devices 103 can be quite short (e.g., less than two inches apart).

The client application 236 can also be executed in a client device 103 to access network content served up by the computing environment 203 or other servers, thereby rendering a user interface 239 (representative of a first user interface 239a and a second user interface 239b) on the display. To this end, the client application 236 can include a browser, a dedicated application, or other executable, and the user interface 239 can include a network page, an application screen, or other user mechanism for obtaining user input. The client device 103 can be configured to execute applications beyond the client application 236 such as email applications, social networking applications, word processors, spreadsheets, or other applications.

Also, various data is stored in a client data store 240 that is accessible to the client device 103. The client data store 240 can include passkey data 242, biometric data 245, or other suitable data. The passkey data 242 can include data associated with the generation, the management, and the transfer of passkeys. The passkey data 242 can include asymmetric key pair data, symmetric key data, historical data for transferring passkeys, user identifier data, domain identifier data, or other suitable data.

The biometric data 245 can include biometric scans (e.g., facial recognition, fingerprint scans, palm scans, voice fingerprinting, etc.) associated with the user. The biometric data 245 can be used as part of the verification process for authorizing the use or transfer of the passkey.

The domain device 106 can represent a networked computing device associated with a domain site (e.g., a web site) or an application (e.g., a mobile application, a desktop application, etc.). For example, the domain device 106 can be accessed in order to authorize access to services, functionality, and data associated with the domain device 106. In some examples, the domain device 106 may also store similar data as the data store 212.

Next, a general description of the operation of the various components of the network environment 100 is provided. To begin, a first user can attempt to login, using a first client device 103a, into a web site hosted by the domain device 106. The first user may desire to access a networked resource available at the domain device 106.

Upon accessing the web site, the first client device 103a can receive a passkey request for logging in. The first client device 103a may not have a passkey associated with the website. In other examples, the first user may not want to use their passkey for one or more reasons (e.g., insufficient access privileges, insufficient funds for a payment credential, etc.). As a result, the first client application 236a of the first client device 103a can select a second user with a second user identifier from a contact list. The first client device 103a can transmit a push notification to the second client device 103b associated with the second user identifier 221. The second client device 103b can display the push notification and the push notification can request permission for the first user identifier 221 to have authorization to use the passkey associated with the second user identifier 221.

On the second client device 103b, the second user can have a first option to authorize a one-time use of the passkey or a second option for a permanent transfer of the passkey to the first client device 103a. The permanent transfer can provide the first client device 103a authorization to use the passkey of the second user without restrictions. Upon a selection of either option, the passkey authorization can be configured and transferred between the first client device 103a and the second client device 103b using the local area network 109 (e.g., an NFC session).

For example, upon a selection of the first option, the second client device 103b can sign a payload request received from the first client device 103a. The second client device 103b can sign the payload request using a private key stored in the second client data store 240b. The second client device 103b can use a private key generated for use with the domain site. Upon signing the payload request, the second client device 103b can transmit the signed payload request to the first client device 103a via an NFC session (e.g., local area network 109) established between the client devices 103. The first client application 236a can transmit the signed payload to the web site of the domain device 106. The transmission of the signed payload provides a one-time authorization of the passkey for the first user. The first client application 236a will not be permitted authorization again unless another authorization is approved by the second user.

In another example, upon a selection of the second option, the second client device 103b and the first client device 103a can generate a symmetric key for encrypting and decrypting data between the two client devices 103. The second client device 103b can use the symmetric key to encrypt the private key. The second client device 103b can transmit the encrypted key to the first client device 103a via an NFC session. Subsequently, the first client device 103a can decrypt the encrypted private key and store the private key and a domain identifier in the first client data store 240a. With the private key from the second client device 103b, the first client device 103a can sign subsequent passkey requests from the domain sites without the need for explicit authorization form the second client device 103b.

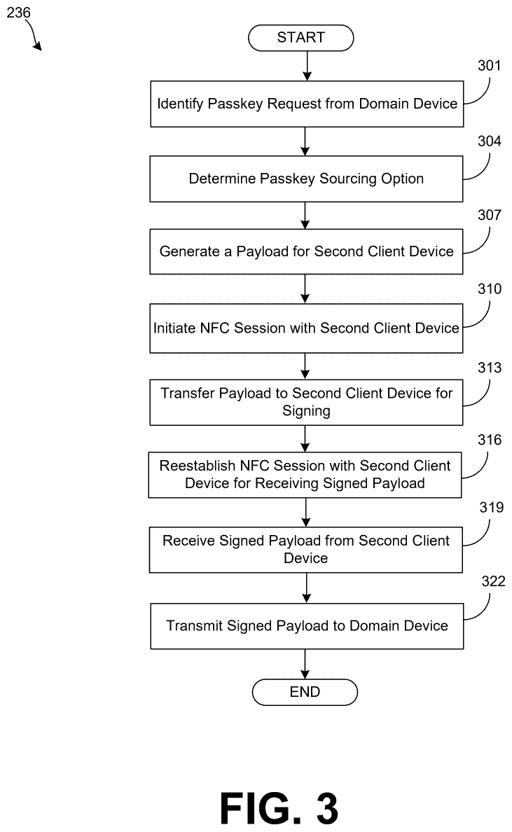

Referring next to FIG. 3, shown is a flowchart that provides one example of the operation of a portion of the first client application 236a. The flowchart of FIG. 3 provides merely an example of the many different types of functional arrangements that can be employed to implement the operation of the depicted portion of the client application 236. As an alternative, the flowchart of FIG. 3 can be viewed as depicting an example of elements of a method implemented within the network environment 100. The subsequently described functionality can be executed by the first client application 236a and/or the second client application 236b. The described functionality can represent a single-use or a one-time authorization of a passkey of a first user by a second user.

Beginning with block 301, the first client application 236a can identify a passkey request from a domain device 106. The passkey request can represent a user attempting to login to a web site hosted at the domain device 106. In order to verify the identity of the user, the domain device 106 can transmit the passkey request to the first client device 103a. The passkey request can include a domain identifier for the domain device 106. The passkey request can represent part of a user journey on the web site.

In block 304, the first client application 236a can determine a passkey sourcing option from the first user interface 239a. In some examples, the first user interface 239a can include a first option for sourcing the passkey from the first client device 103a and a second option for sourcing the passkey from an external device (e.g., the second client device 103b). For the purpose of this discussion, it is assumed that the second option is selected by the first user.

In some examples, the first client application 236a can determine a second user for sourcing the passkey based at least in part on the first user selecting the second user from a contact list, a social media list, or other suitable contacts accessible to the first client device 103a. The selected contact can be used to identify a device identifier for the second client device 103b. Alternatively, the first client application 236a can also allow the entry of a device identifier for the second client device 103b by way of the first user interface 239a. In some examples, the first client application 236a and the second client application 236b are executed in the foreground of an operating system for the transfer process.

In block 307, the first client application 236a can generate a payload for the second client device 103b to sign based at least in part on the passkey request. The payload can be configured to permit the first client device 103a authorization to use a passkey of the second client device 103b at the domain device 106. The payload can include a domain identifier for the domain device 106. In some examples, the payload can include a template data structure for data elements associated with the passkey request. For instance, the template data structure can include a domain identifier for the domain device 106, a user identifier 221 for the first user, protocol transfer instructions (e.g., executing the data transfer via an NFC session) and other suitable data.

In some examples, the first client application 236a and the second client application 236b can generate a symmetric key using a key derivation function (KDF) and a master key (e.g., a secret key) from each client device 103. In some examples, the master key is embedded with a Whitebox cryptography technique. Whitebox cryptography can represent a cryptographic technique that embeds the master key in the application code. The master key can be embedded in such a way that the master key cannot be distinguished from the application code, which can involve using encryption and obfuscation techniques. In other examples, a hardware-based implementation can be used, such as a secure element or a trusted platform module (TPM). The TPM can represent a secure cryptographic coprocessor chip or a dedicated microcontroller for handling cryptographic key data. The first client application 236a and the second client application 236b can exchange key material for generating the symmetric key. The symmetric key can be used to encrypt the payload and/or the signed payload.

In block 310, the first client application 236a can initiate an NFC session with the second client device 103b. The NFC session can be initiate by a first NFC connection established between the first client device 103a and the second client device 103b. In some examples, the NFC connection can be established using a non-ISO 7816-4 NFC tag standard. The first client application 236a can generate an NFC session identifier for the NFC session. Additionally, in some examples, the first client application 236a and the second client application 236b is executed in the foreground (e.g., the client applications are visible on the screen of the client devices 103) of the operating system.

In block 313, the first client application 236a can transfer the payload to the second client device 103b for signing. In some examples, after the payload is transferred, the NFC session can be terminated. After receiving the payload, the second client device 103b can display the second user interface 239b and the second user interface 239b can indicate the first user requests permission to use the passkey of the second user for accessing the domain site.

In block 316, the first client application 236a can reestablish the NFC session with the second client device 103b. The NFC session can be reestablished by way of a second NFC connection established between the first client device 103a and the second client device 103b. In some examples, the NFC session identifiers is used to reengage the NFC session.

In block 319, the first client application 236a can receive, via the NFC session, the signed payload. The signed payload can be signed by a private key stored on the second client device 103b. The signed payload can include a digital signature of the second client device 103b that was generated by signing the payload with the private key of the second client device 103b. The signed payload can also include a second user identifier 221 associated with second user of the second client device 103b. In some examples, the signed payload is encrypted and the first client application 236a uses the symmetric key to decrypt the signed payload.

In block 322, the first client application 236a can transmit the signed payload to the domain device 106. The domain device 106 can verify the signed payload by checking the second user identifier 221 of the second user and the digital signature generated by the second client device 103b. Upon verification, the first client application 236a can be granted access to the network resources associated with the domain device 106. In some examples, the second client application 236b can track the quantity of authorizations, the devices that have been authorized, a timestamp for the authorization, and other suitable data. Then, the first client application 236a can proceed to the end.

In some examples, the client application 236 can provide a one-time authorization of a passkey from a first user profile 221 to a second user profile, in which the first user profile 221 and the second user profile 221 are owned by the user. The two user profiles 221 can be associated with the client device 103. In some examples, the first user profile 221 can authorize use of a passkey for a second user profile 221 while determining the passkey sourcing option (e.g., block 304) for a web site. In some example implementations, the client application 236 can generate a payload to be signed in association with the first user profile 215. While using the second use profile 221, the client application 236 can transmit the signed payload to the web site.

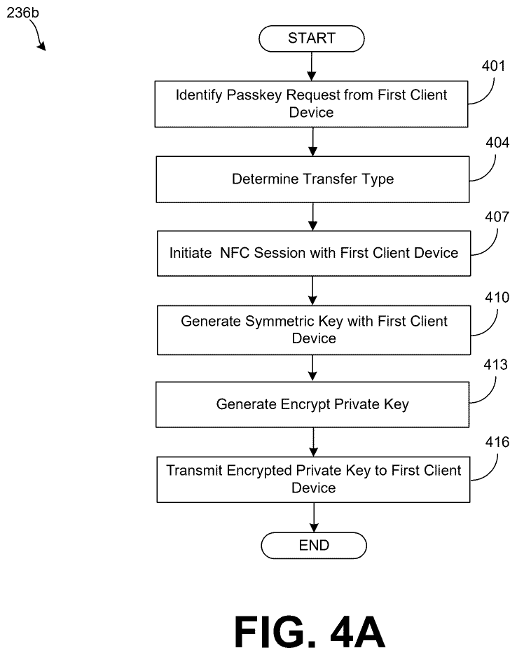

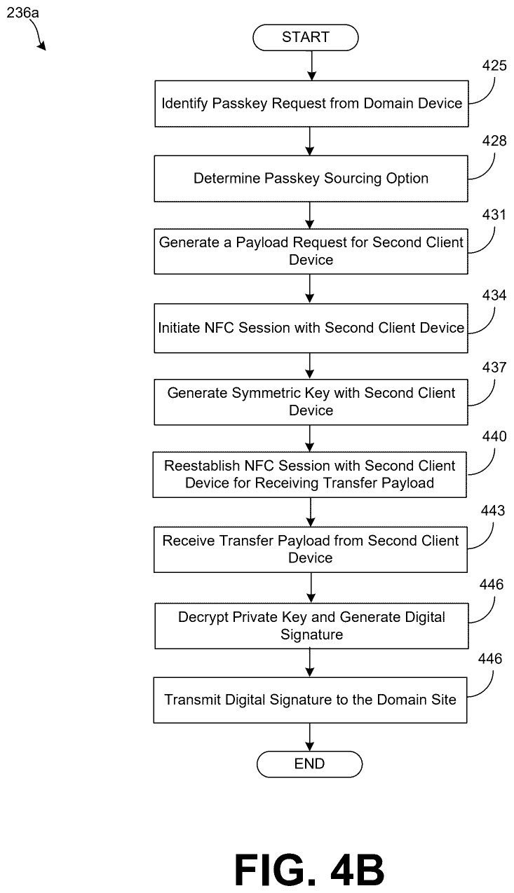

Referring next to FIG. 4A, shown is a flowchart that provides one example of the operation of a portion of the second client application 236b. The flowchart of FIG. 4A provides merely an example of the many different types of functional arrangements that can be employed to implement the operation of the depicted portion of the second client application 236b. As an alternative, the flowchart of FIG. 4A can be viewed as depicting an example of elements of a method implemented within the network environment 100. The subsequently described functionality can be executed by the first client application 236a and/or the second client application 236b. The subsequently described functionality can represent a permanent transfer of a private key from the second client application 236b to the first client application 236a.

Beginning with block 401, the second client application 236b can identify a passkey request from the first client device 103a. In some examples, the second client application 236b can receive the passkey request as a notification, such as a push notification, an email message, a text message, and other suitable forms of communication. Upon a selection of the notification, the second client application 236b can be activated into the foreground of operating system execution. The

In some examples, the second client application 236b can identify the passkey request from an NFC connection established with the first client application 236a. The passkey request can include a first user identifier 221, a domain site identifier, information about the request (e.g., purchase information, information regarding the access type, etc.), a payload for accessing the domain site, and other suitable data.

In block 404, the second client application 236b can determine a transfer type. The second client application 236b can display a second user interface 239b that includes a first option for a one-time passkey authorization and a second option for a permanent passkey transfer. When the second user selects the first option, then the second client application 236b performs a process for signing the payload and returning the signed payload to the first client application 236a (e.g., see the one-time access authorization in FIG. 3). For the purposes of FIG. 4A, it is assumed that the second user selects the second option for a permanent passkey transfer. As such, the permanent passkey transfer is determined to be the transfer type.

In some examples, the second client application 236b can be used to select a passkey for the transfer type based at least in part on the domain site identifier. For example, the second client application 236b can retrieve the available passkeys for the domain site from the second client data store 240b. If there are multiple passkeys available for the domain site, then the second client application 236b can make a selection of a passkey from the second user interface 239b. Upon a selection of the passkey, the second client application 236b can proceed to block 407.

In block 407, the second client application 236b can initiate an NFC session with the first client device 103a. In some examples, the second user interface 239b can display a notification to initiate the NFC connection by placing the second client device 103b in close proximity with the first client device 103a. By generating an NFC connection, the second client application 236b and/or the first client application 236a can generate an NFC session identifier for the NFC session.

In block 410, the second client application 236b can generate a symmetric key with the first client device 103a. In some examples, the second client application 236b can generate the symmetric key by exchanging key material with the first client device 103a. The symmetric key can be generated using the key derivation function and a master key (e.g., a secret key) from each client device 103. In some examples, the master key is embedded with Whitebox cryptography technique. In other examples, a hardware-based implementation can be used, such as a secure element or a trusted platform module (TPM). The symmetric key can be used for encryption and decryption of the private key and other passkey related data

In block 413, the second client application 236b can generate an encrypted private key based at least in part on a private key associated with the first client device 103a and the symmetric key. In some examples, the symmetric key is Advanced Encryption Standard symmetric key.

In block 416, the second client application 236b can transfer the encrypted private key to the first client device 103a in a transfer payload via the NFC session. In some examples, the functionality of FIG. 3 can be executed among one or more NFC connections for the NFC sessions. As such, in some examples, the NFC session is reestablished by initiating one or more subsequent NFC connections. In some examples, the second client application 236c add the transfer to an activity log of transfer for the passkey.

In some examples, the second client application 236b can request permission to transfer the passkey to the first client application 236b by transmitting an authorization request to the authorization service 209. The authorization request can include the intended recipient (e.g., the first user identifier 221). The authorization service 209 can respond with an approval or a denial of the transfer based at least in part on a risk assessment score associated with the first user identifier 221 or device data 230. For example, if the risk assessment score exceeds a threshold (e.g., the first user identifier 221 has a compromised device), then the authorization service 209 can respond with a denial. If an approval is received, then the second client application 236b can proceed with the transfer of the encrypted private key. Then, the second client application 236b can proceed to the end.

In some examples, the passkey request can be generated by the first client application 236a without the context of a domain site or a user journey. The first client application 236 can transmit the passkey request as a stand alone request for transferring the passkey (e.g., a private key associated with the passkey) to a second user identifier 221, which may be associated with a different client device 103.

In some examples, the user can have multiple user profiles 221 associated with a domain site, the computing environment 203, or other suitable entities. The user can execute a permanent passkey transfer (e.g., a transfer of the private key associated with a passkey) from a first user profile 215 to a second user profile 215, in which the first user profile 215 and the second user profile 215 are owned by the user. As such, the user can copy the passkey from the first user profile 215 to the second user profile 215.

Referring next to FIG. 4B, shown is a flowchart that provides one example of the operation of a portion of the first client application 236a. For example, FIG. 4B describes the functionality of the first client application 236a receiving and storing the private key from the second client device 103b. The flowchart of FIG. 4B provides merely an example of the many different types of functional arrangements that can be employed to implement the operation of the depicted portion of the first client application 236a. As an alternative, the flowchart of FIG. 4B can be viewed as depicting an example of elements of a method implemented within the network environment 100. The subsequently described functionality can be executed by the first client application 236a and/or the second client application 236b. The described functionality can represent receiving a permanent transfer of a private key and using the private key to generate a digital signature for a passkey verification.

Beginning with block 425, the first client application 236a can identify a passkey request from the domain device 106. The passkey request can represent a user attempting to login to a web site hosted at the domain device 106. In order to verify the identity of the user, the domain device 106 can transmit a passkey request to the first client device 103a. The passkey request can include a domain identifier for the domain device 106.

In block 428, the first client application 236a can determine a passkey sourcing option. In some examples, the user interface 239a can include a first option for sourcing the passkey from the first client device 103a and a second option for sourcing the passkey from an external device (e.g., the second client device 103b). For the purpose of this discussion, it is assumed that the second option is selected by the user.

In block 431, the first client application 236a can generate a payload request for the second client device 103b. The payload request can be configured to permit the first client device 103a authorization to use a passkey of the second client device 103b at the web site (e.g., at the domain device 106). The payload request can include a domain identifier for the domain device 106. In some examples, the payload request can include a template data structure for data elements associated with the passkey request.

In some examples, the first client application 236a and the second client application 236b can generate a symmetric key using a key derivation function (KDF). The first client application 236a and the second client application 236b can exchange key material in order to generate the symmetric key. The symmetric key can be used to encrypt the payload and/or the signed payload.

In block 434, the first client application 236a can initiate an NFC session with the second client device 103b. The first client application 236a and/or the second client application 236b can initiate an NFC session by a first NFC connection established between the first client device 103a and the second client device 103b. In some examples, the NFC connection can be established using a non-ISO 7816-4 NFC tag standard or other suitable NFC protocol standards. The first client application 236a can generate an NFC session identifier for the NFC session. Additionally, in some examples, the first client application 236a and/or the second client application 236b is executed in the foreground (e.g., the client applications 236 are visible on the screen of the client devices 103) of the operating system. In some examples, the client applications 236 can track the passkey authorizations and configure passkey settings when the client applications 236 are executed in the foreground during the passkey transfers.

In block 437, the first client application 236a can generate symmetric key with the second client device 103b. The first client application 236a and the second client application 236b can generate a symmetric key using a key derivation function (KDF) and a master key (e.g., a secret key) from each client device 103. In some examples, the master key is embedded with a Whitebox cryptography technique. In other examples, a hardware-based implementation can be used, such as a secure element or a trusted platform module (TPM). The first client application 236a and the second client application 236b can exchange key material for generating the symmetric key. The symmetric key can be used to encrypt the payload and/or the signed payload.

In block 440, the first client application 236a can reestablish the NFC session with the second client device 103b for receiving the transfer payload. The NFC session can be reestablished by way of a second NFC connection established between the first client device 103a and the second client device 103b. In some examples, the NFC session identifier is used to reengage the NFC session.

In block 443, the first client application 236a can receive the transfer payload from the second client device 103b by way of the NFC session. The transfer payload can include the encrypted private key, a domain site identifier, a user identifier 221 associated with the domain site (e.g., a user identifier 221 for the second user at the domain site), and other suitable data.

In block 446, the first client application 236a can decrypt the encrypted private key that is in the transfer payload using the symmetric key. In some examples, the private key can be stored in the client data store (e.g., in a secure element portion of the first client data store 240a).

In block 449, the first client application 236a can transmit the digital signature to the domain site. In some examples, the first client application 236a can also transmit a user identifier 221 associated with the digital signature for verification to the domain site. The domain site (e.g., the domain device 106) can retrieve a public key associated with the user identifier 221 of the second user for verifying the digital signature. Upon verifying the digital signature with the public key associated with the user identifier 221, then the first client application 236a can be granted access to the domain site of the domain device 106. Then, the first client application 236a can proceed to the end.

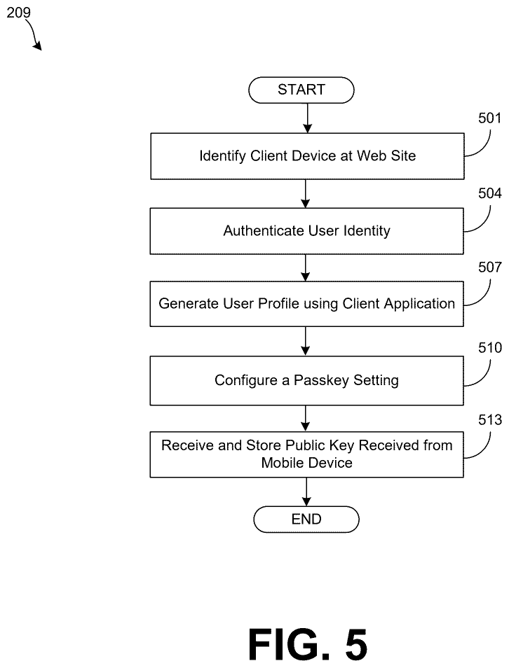

Referring next to FIG. 5, shown is a flowchart that provides one example of the operation of a portion of the authentication service 209. The flowchart of FIG. 5 provides merely an example of the many different types of functional arrangements that can be employed to implement the operation of the depicted portion of the authentication service 209. As an alternative, the flowchart of FIG. 5 can be viewed as depicting an example of elements of a method implemented within the network environment 100.

Beginning with block 501, the authentication service 209 can identify a client device 103 accessing a web site associated with the computing environment 203. Upon visiting the website, the authentication service 209 can receive a request to generate a passkey for the computing environment 203. It is assumed that the authentication service 209 is associated with the client application 236 executed by the client device 103. The client application 236 can be a mobile application that was installed by the authentication service 209 or other service associated with the computing environment 203. As such, the computing environment 203 can be a passkey issuer.

In block 504, the authentication service 209 can authenticate a user identity of a user operating the client device 103. The user is authenticated because the passkey would be associated with the user. In some examples, the authentication service 209 can authenticate the user identity using single or multiple factor authentication techniques. For example, the authentication service 209 can start an authentication process on a client device 103 owned by the user and transmit an authentication code or credential to a second device owned by the user.

In some examples, the authentication service 209 can be in data communication with the client application 236 for the authentication process. As such, the client application 236 can execute functionality as part of the authentication process. For instance, the client application 236 can retrieve and provide data (e.g., personal identifying data, device data 230, etc.) to the authentication service 209.

In some examples, the client application 236 can receive a selection of a deep link by the user. The activation of the deep link can trigger a web site (e.g., a uniform resource locator) associated with the authentication service 209 or activate a portion of the authentication workflow as part of the client application 236.

In block 507, the authentication service 209 can generate user profile 215 using the client application 236 executed on the client device 103. The authentication service 209 can receive personal identifying information, device data 230 associated with the client device 103, and other suitable profile data.

In block 510, the authentication service 209 can configure a passkey setting. The authentication service 209 can receive one or more configuration settings for the passkey from the client device 103. For example, the configuration settings can include automatically syncing the passkeys for one or more devices associated with the user. For instance, a configuration setting can indicate the user wants the passkey to be synced to a mobile phone and a mobile tablet, but not a laptop owned by the user. In other examples, the configuration setting specified by the user can indicate to sync the passkey to only the mobile phone.

In block 513, the authentication service 209 can receive and store public key from the client device 103. In some examples, the authentication service 209 can provide an instruction for the client device 103 to generate an asymmetric-encryption key pair (e.g., a private key and a respective a public key) for the passkey. The client application 236 can store the private key in the client data store 240. The client application 236 can transmit the public key to the authentication service 209. Upon receiving the public key, the authentication service 209 can store the public key in association with the user profile 215 for the user (e.g., as key data 224) in the data store 212.

In some examples, the authentication service 209 can provide different configurations for syncing the newly generated passkey. For example, the user may have multiple user profiles 215 for an organization (e.g., a bank, credit company, a financial institution, etc.). The authentication service 209 can display a user interface 239 that allows the user to select which user profile 221 that user wants to associate or sync the newly generated passkey. The authentication service 209 can perform syncing operations (e.g., copying the passkey) on eligible devices may be based on the devices (e.g., specified device identifiers), user profile 221, and the security risks. In some instances, the authentication service 209 can generate a risk assessment score for each device identifier (e.g., device data 236) and determine whether to permit a syncing operation for a device (e.g., device identifier) based at least in part on the risk assessment score for the device. As such, if a device identified has a risk assessment score below a threshold, then the authentication service 209 can prevent a syncing operations.

In some examples, the authentication service 209 can display a configuration user interface 239 on the client device 103 for adding and removing a passkey of a domain site from any of the user profiles 215 and from any device identifiers (e.g., client devices 103) associated with the user. The client application 236 can be executed to allow for the user interface 239 to be used for these configuration setting adjustments.

In some examples, the authentication service 209 can track an entire lifecycle of the passkey from its creation by a client device 103, on the client devices 103 it has been synced, the new user profiles 215 it was shared, the synced/shared client devices 103 from where the passkey is used, and other suitable situations. Further, in some examples, the authentication service 209 can enable the user to configure the passkey to be stored in at the computing environment 203 instead of storing the passkey on the client device 103. Then, the authentication service 209 can proceed to the end.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 3-5 show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts of FIGS. 3-5 show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts of FIGS. 3-5 can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 203.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a first client device comprising a processor and a memory; and
machine-readable instructions stored in the memory that, when executed by the processor, cause the first client device to at least:
identify a passkey request for logging into a domain device;
generate a payload for a second client device to sign based at least in part on the passkey request, the payload being configured to permit authorization to use a passkey of the second client device;
initiate a near field communication (NFC) session with the second client device based at least in part on the payload being generated;
transmit, via the NFC session, to the second client device the payload to be signed for permitting use of the passkey by the first client device;
receive, via the NFC session, a signed payload from the second client device; and
transmit the signed payload to the domain device for granting the first client device access based at least in part on the passkey request.

2. The system of claim 1, wherein the payload is generated for the passkey to be used as a single-use credential or a single session credential.

3. The system of claim 1, wherein the machine-readable instructions, when executed by the processor, cause the first client device to at least:
display a user interface that requests whether the passkey should be accessed from the first client device or the second client device based at least in part on the passkey request, wherein the NFC session is initiated based at least in part on a selection of the second client device.

4. The system of claim 1, wherein the initiation of the NFC session further causes the computing device to at least:
generate an NFC session identifier for the NFC session based at least in part on a first NFC connection, wherein the first NFC connection is terminated after transmitting the payload; and
initiate a second NFC connection with the second client device based at least in part on the NFC session identifier, wherein the second NFC connection reestablishes the NFC session between the first client device and the second client device.

5. The system of claim 4, wherein the signed payload comprises a digital signature generated by the second client device using a private key stored on the second client device.

6. The system of claim 1, wherein the payload comprising a domain identifier associated with the domain device.

7. The system of claim 1, wherein the machine-readable instructions, when executed by the processor, cause the first client device to at least:
generate a symmetric key in association with the second client device based at least in part on the initiation of the NFC session.

8. A method, comprising:
identifying, by a first client device, a passkey request for logging in to a domain device;
generating, by the first client device, a payload for a second client device to sign based at least in part on the passkey request, the payload being configured to permit authorization to use a passkey of the second client device;
initiating, by the first client device, a near field communication (NFC) session with the second client device based at least in part on the payload being generated;
transmitting, by the first client device via the NFC session, to the second client device the payload to be signed for permitting use of the passkey by the first client device;
receiving, by the first client device via the NFC session, a signed payload from the second client device; and
transmitting, by the first client device, the signed payload to the domain device for granting the first client device access based at least in part on the passkey request.

9. The method of claim 8, wherein the payload is generated for the passkey to be used as a single-use credential or a single session credential.

10. The method of claim 8, further comprising:
displaying, by the first client device, a user interface that requests whether the passkey should be accessed from the first client device or the second client device based at least in part on the passkey request, wherein the NFC session is initiated based at least in part on a selection of the second client device.

11. The method of claim 8, wherein initiating the NFC session further comprising:
generating, by the first client device, an NFC session identifier for the NFC session based at least in part on a first NFC connection, wherein the first NFC connection is terminated after transmitting the payload; and
initiating, by the first client device, a second NFC connection with the second client device based at least in part on the NFC session identifier.

12. The method of claim 11, wherein the signed payload comprises a digital signature generated by the second client device using a private key stored on the second client device.

13. The method of claim 8, wherein the payload comprising a domain identifier associated with the domain device.

14. The method of claim 8, wherein further comprising:
generating, by the first client device, a symmetric key in association with the second client device based at least in part on the initiation of the NFC session.

15. A system, comprising:
a first client device comprising a processor and a memory; and
machine-readable instructions stored in the memory that, when executed by the processor, cause the first client device to at least:
identify a passkey request from a second client device for logging into a domain device;
initiate a near field communication (NFC) session with the second client device;
generate a symmetric key with the second client device based at least in part on the passkey request;
generate an encrypted private key based at least in part on a private key associated with the first client deice and the symmetric key; and
transmit, via the NFC session, the encrypted private key to the second client device in a transfer payload.

16. The non-transitory, computer-readable medium of claim 15, wherein the passkey request comprises a domain identifier associated with the domain device.

17. The non-transitory, computer-readable medium of claim 15, wherein the machine-readable instructions, when executed by the processor, further cause the computing device to at least:
determine a transfer type for the passkey request based at least in part on the passkey request.

18. The non-transitory, computer-readable medium of claim 15, wherein the symmetric key is generated using a key derivation function and a master key stored in the first client device.

19. The non-transitory, computer-readable medium of claim 15, wherein the encrypted private key is further based at least at in part on a domain identifier for the domain device.

20. The non-transitory, computer-readable medium of claim 15, wherein the machine-readable instructions, when executed by the processor, further cause the computing device to at least:
generate transfer data based least in part on the transmission of the encrypted private key to the second client device, the transfer data comprises at least one of a user identifier associated with the second client device, a transfer time, or the domain identifier.
